(19) United States
(12) Patent Application Publication
(10) Pub. No.: US 2025/0045619 A1
(43) Pub. Date: Feb. 6, 2025

(54) Conditional Loss Function for Training a Multitask Machine Learning Model

(71) Applicant: Maplebear Inc., San Francisco, CA (US)

(72) Inventors: Jin Zhang, Mountain View, CA (US); Trace Levinson, Brooklyn, NY (US)

(21) Appl. No.: 18/228,569

(22) Filed: Jul. 31, 2023

(51) Int. Cl. G06N 20/00

(52) U.S. Cl. CPC G06N 20/00

(57) ABSTRACT

A computing system uses a conditional loss function to train a multitask model. A conditional loss function is a loss function whose output is conditional on which branch's output the conditional loss function is scoring. Specifically, when the conditional loss function is applied to an output score generated by a branch whose corresponding task is not relevant to the training example for the output score, the conditional loss function generates a loss score that, when used in backpropagation, does not significantly change the parameters of the multitask model. The computing system uses conditional loss functions to generate a loss score for each output score generated by applying a multitask model to features of a set of training examples. If the task indicators indicate that the branch task is not relevant to the training example, the conditional loss function outputs a loss score of zero.

### BACKGROUND

Computing systems, such as online systems, may use multitask machine-learning models to perform tasks required by those systems. Multitask models are machine-learning models with a branched structure. Each branch has layers that are trained to perform a specific function, but receives features from a set of shared layers that extracts certain intermediary features from the input data where these intermediary features are useful for each of the branches. For example, a computing system may use a multitask model whose tasks are to identify animals that are depicted in an image. Each branch of the multitask model may be trained to predict whether an image depicts a particular type of animal, but the layers of each branch receive features from a set of shared layers that perform an initial feature extraction from the image data. In this way, because each of the branches leverages a common set of shared layers which are trained based on training data for all of the tasks, multitask models ease the burden of training a machine-learning model to perform tasks rather than training a different model specifically for each task.

However, multitask models have their own training challenges. Training examples tend to represent only a subset of tasks that a multitask model performs, and branches that are not relevant to a training example should not be updated based on those training examples. For example, a multitask model may predict whether users will perform different interactions with content served by an online system. One branch of this model may predict whether a user will share the content with another user on the online system and another branch may predict whether a user will add a comment to the content. Because a training example that describes an instance where a user has commented on a piece of content may not include information on whether the user shared the content, the training example is likely not usable to train the branch for whether a user will share the content. Thus, computing systems training multitask models generally must take care that training examples are only used to train the correct branches of the multitask models.

In many cases, engineers have enough control over the implementation of a multitask model to ensure that only the correct branches are trained for each training example. However, in some cases, engineers may use machine-learning platforms or software libraries (such as TensorFlow) to implement their multitask models, and these libraries may not allow engineers sufficient control in controlling which branches of a multitask model are trained based on a training example. For example, some machine-learning libraries may require that a training example be used to update all branches of a multitask model, which limits the contexts in which multitask models can be used. Thus, engineers using these libraries may be unable to implement multitask models that require that only a subset of branches of the multitask models be updated by training examples.

### SUMMARY

In accordance with one or more aspects of the disclosure, a computing system, such as an online system, uses a conditional loss function to train a multitask model. A conditional loss function is a loss function whose output is conditional on which branch's output the conditional loss function is scoring. Specifically, when the conditional loss function is applied to an output score generated by a branch whose corresponding task is not relevant to the training example for the output score, the conditional loss function generates a loss score that, when used in backpropagation, does not significantly change the parameters of the multitask model.

For example, the computing system may train the multitask model based on a set of training examples. Each of these training examples include a set of input features, a label, and a set of task indicators that indicate the tasks to which each training example is relevant. To train the multitask model, the computing system applies the multitask model to the input features of a training example to generate a set of output scores. Each output score corresponds to a branch of the multitask model that generated the output score.

The computing system then generates a loss score for each output score using conditional loss functions. Each conditional loss function corresponds to one of the branches of the multitask model and takes, as inputs, a generated output score, the training example's label, and the training example's set of task indicators. If the task indicators indicate that the branch task is relevant to the training example, the conditional loss function outputs a loss score that represents the multitask model's performance in generating the output score. Otherwise, the conditional loss function may output a loss score of zero or some other loss score that, when used during backpropagation, does not significantly change the parameters of the multitask model.

Thus, the described method for training a multitask model improves on machine-learning technology. For example, when a training example is not relevant to the task of a branch that produced an output score, the parameters of the multitask model are not updated based on the performance of that branch on that training example. Consequently, by using the conditional loss function, the computing system can use a machine-learning library or platform (such as TensorFlow) that requires that all branches be trained based on a training example without a branch being trained on irrelevant training examples. Therefore, a computing system can use certain machine-learning libraries or platforms to implement multitask models for tasks that were otherwise infeasible or impossible.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart for a method of training a multitask model using a conditional loss function, in accordance with some embodiments.

FIG. 4 illustrates an example structure of a multitask model, in accordance with some embodiments.

FIG. 5 illustrates an example data flow through a multitask model when training the multitask model on a training example, in accordance with some embodiments.

### DETAILED DESCRIPTION

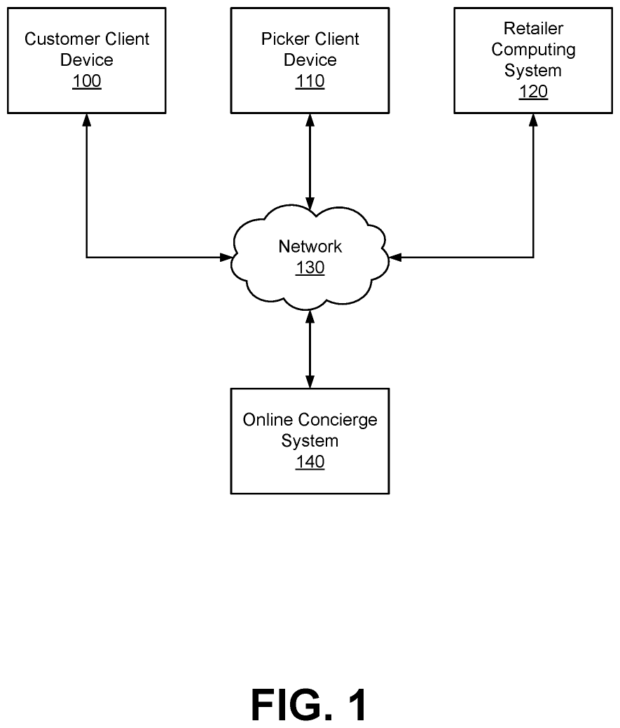

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

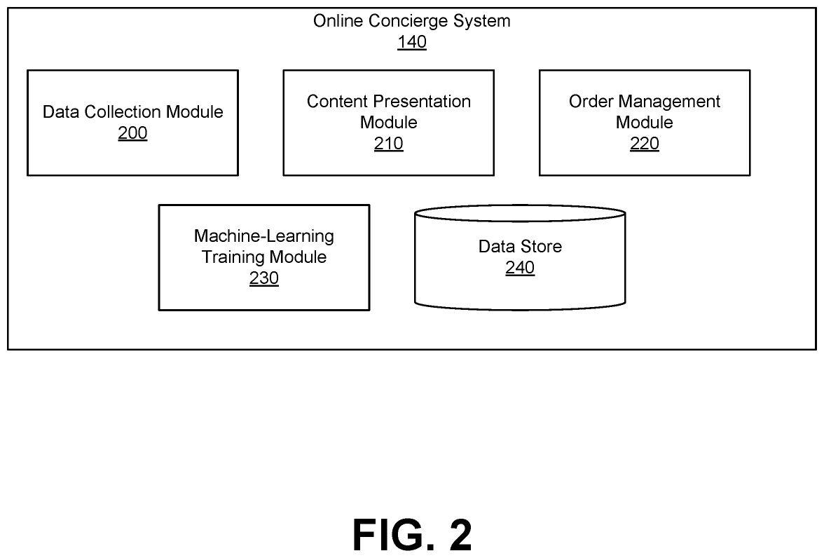

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 trains a multitask model using a conditional loss function. A conditional loss function is a loss function whose output is conditional on which branch's output the conditional loss function is scoring. Specifically, when the conditional loss function is applied to an output score generated by a branch whose corresponding task is not relevant to the training example for the output score, the conditional loss function generates a loss score that, when used in backpropagation, does not significantly change the parameters of the multitask model. An example method for training a multitask model using a conditional loss function is described in further detail below.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

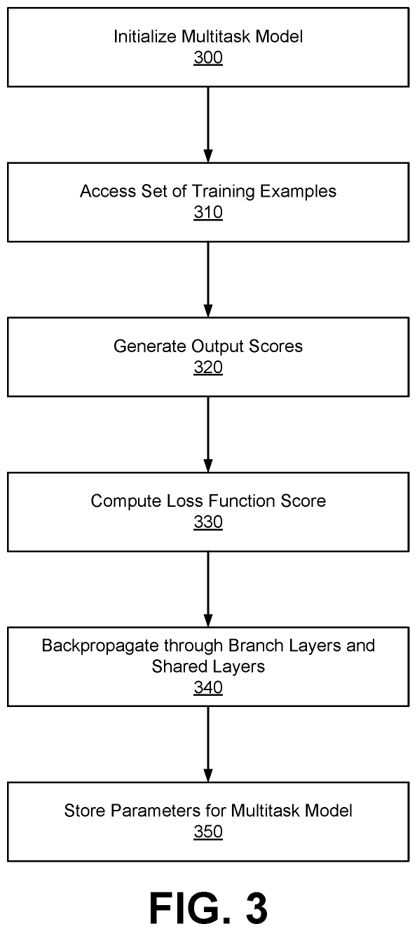

FIG. 3 is a flowchart for a method of training a multitask model using a conditional loss function, in accordance with some embodiments. Alternative embodiments may include more, fewer, or different steps from those illustrated in FIG. 3, and the steps may be performed in a different order from that illustrated in FIG. 3. These steps may be performed by an online system (e.g., online concierge system 140). Additionally, each of these steps may be performed automatically by the online concierge system without human intervention.

The online system initializes 300 the multitask model. A multitask model is a machine-learning model that is structured to perform multiple “tasks,” such as predictions or classifications. These tasks may be independent of each other in that one prediction is not necessarily dependent on another prediction. For example, a multitask model may perform the tasks of predicting the average temperature on a given day and the likelihood of rain on a given day.

The multitask model has a set of shared layers and multiple sets of branch layers. When the multitask model is being applied to input features, the input features to the multitask model initially pass through the set of shared layers, which generate a set of intermediary features. The output layer of the set of shared layers is connected to the input layers of the sets of branch layers. Thus, the multitask model passes the intermediary features from the shared layers to each of the sets of branch layers. The shared layers thereby perform an initial extraction of important features from the input features, and this extraction can be leveraged by each of the branches when the intermediary features are passed to each set of branch layers.

Each of the branches of the multitask model corresponds to one of the tasks performed by the multitask model. Each branch includes a set of branch layers that generate the prediction for that task based on the intermediary features from the set of shared layers. The output layers of the branch layers produce a prediction, which is generally a numerical output score. In some cases, the multitask model may be configured such that only a subset of branches produce an output score for a set of input features. For example, the online system may disregard certain branches after training and only use other branches for their output scores (e.g., through a transfer learning process). The multitask model also may be configured such that input features designate which output scores should be generated for the input features, thereby designating which branches should process the intermediate features.

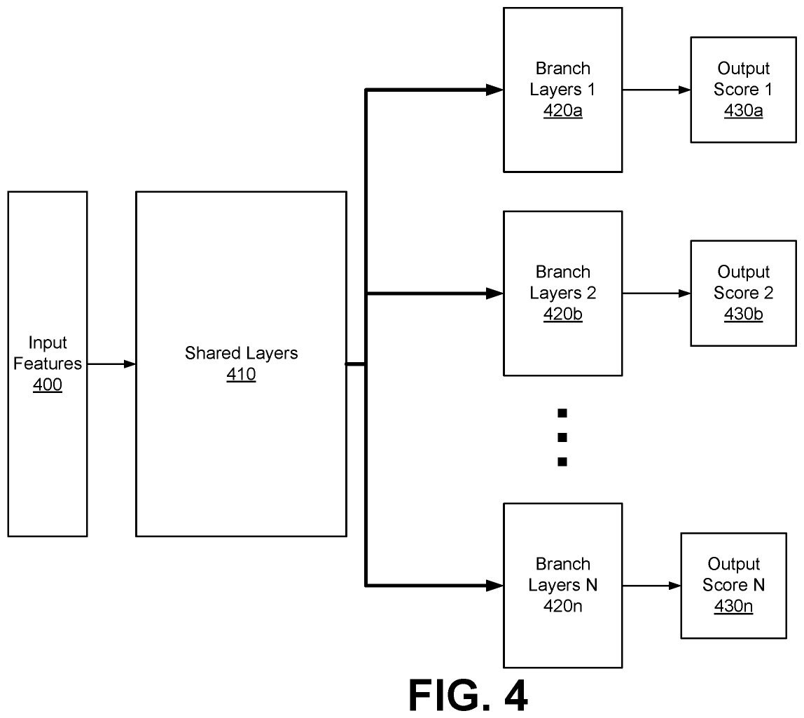

FIG. 4 illustrates an example structure of a multitask model, in accordance with some embodiments. As described above, the multitask model receives the input features 400 through an input layer of the set of shared layers 410. The set of shared layers 410 generate intermediary features that are passed from the output layer of the set of shared layers to the input layer of each of the branch layers 420. Each set of branch layers further processes the intermediary features and outputs, from an output layer, an output score 430 that represents the prediction for the particular task. For example, in the context of an online concierge system, output score 430a may be the likelihood that a user would order an item and output score 430b may be the likelihood that a user would select an item as a replacement for another item.

The online system initializes the multitask model with a set of default parameters for the sets of layers. Each layer in the set of shared layers and the sets of branch layers is a neural network layer of neural nodes. These layers have parameters (e.g., weights and biases) that are used when processing features through the neural network of the multitask model. The default parameters are the initial parameters that the online system assigns to these layers. The default parameters may be random or may be all zeroes.

To train the multitask model, the online system accesses 310 a set of training examples. Each training example has a set of input features to be passed into the multitask model. These input features may be collected by the online system based on user interactions with the online system or a client application of the online system that is operating on a client device. The input features also may be, in whole or in part, automatically generated by the online system.

Each training example also includes a label and a plurality of task indicators. The label represents a correct score that should be output by the multitask model, and the plurality of task indicators indicate which of the branches generates the relevant output score for the training example. As explained above, each of the branches generates predictions for different tasks. However, training examples may only be relevant to a subset of the tasks that the multitask model can perform. For example, a training example that describes an event where a user selected one item as a replacement for another item may not be relevant to the task of predicting whether the user would order the item, or vice versa. Thus, while the label indicates what the output score should be for the input features, the task indicators indicate which of the output scores the label should be compared to for training the multitask model.

The training examples may have a set of task indicators that each correspond to one of the tasks performed by the multitask model. For example, each task indicator may be an indicator bit whose value indicates whether a training example is relevant to a corresponding. Alternatively, rather than having a set of task indicators, the training examples have a single task indicator that indicates a task to which the training example is relevant. For example, each task may be assigned a numerical value and the task indicator may be the numerical value corresponding to the task to which the training example is relevant.

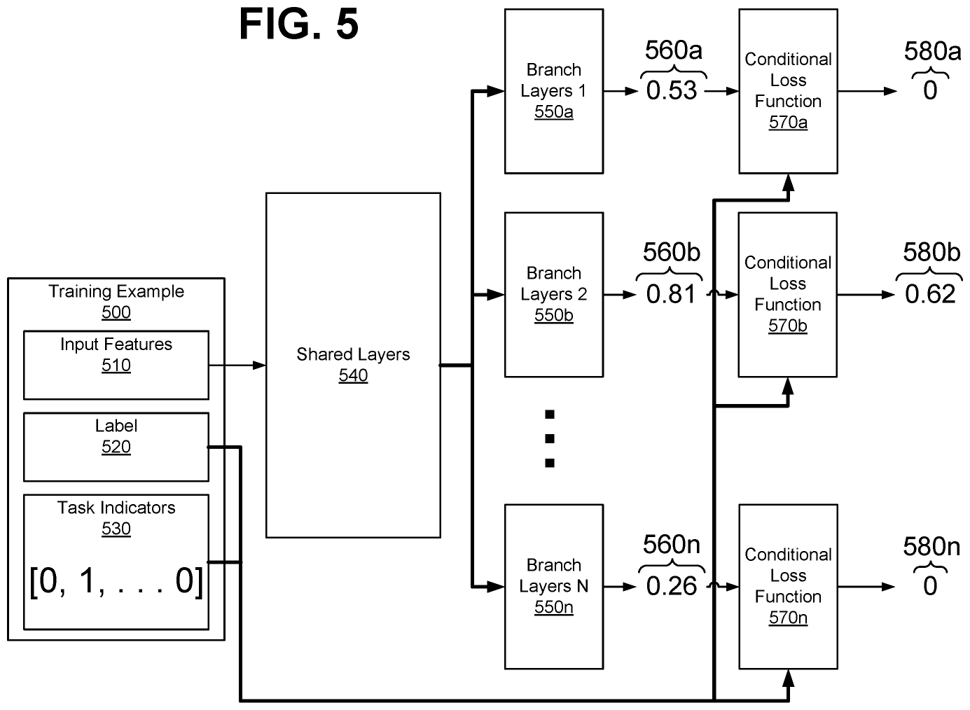

The online system trains the multitask model based using each of the accessed training examples. FIG. 5 illustrates an example data flow through a multitask model when training the multitask model on a training example, in accordance with some embodiments. As noted above, the training example 500 includes a set of input features 510, a label 520, and a set of task indicators 530. In the embodiment illustrated in FIG. 5, the task indicators 530 are indicator bits that indicate, for a corresponding task, the task to which the training example is relevant. Specifically, the task indicators 530 of FIG. 5 indicate that the training example 500 is relevant to the task corresponding to the second set of branch layers 550b. The online system inputs the set of input features 510 to the set of shared layers 540, which generates a set of intermediary features. These intermediary features are passed to each of the sets of branch layers 550, which generate 520 corresponding output scores 560.

The online system computes 330 a loss score 580 for each of the output scores 560. A loss score is a score that represents the performance of the multitask model in computing an output score 560. Typically, a loss score represents how poorly the multitask model performed; that is, a higher loss score indicates a worse performance by the multitask model than a low loss score.

The online system uses conditional loss functions 570 to compute the loss scores 580 for each of the output scores 560. A conditional loss function 570 is a function that computes a loss score 580 for an output score 560 that is conditional on the task indicators 530 for the training example 500. In other words, the output of the conditional loss function, when applied to an output score, depends on whether the training example corresponding to that output score is relevant to the task of the branch that generated the output score.

Conditional loss functions 570 take, as inputs, the generated output score 560 by a set of branch layers 550, the label 520, and the task indicators 530. As illustrated in FIG. 5, each task branch may have a corresponding conditional loss function 570. If the task indicators 530 indicate that the output score 560 is for a task relevant to the training example, the conditional loss function 570 computes the loss score 580 based on the output score 560 and the label. Example algorithms that the conditional loss function may use for computing the loss score include mean squared error, binary cross-entropy loss, categorical cross-entropy loss, Hinge loss, and KL divergence.

If the task indicators 530 indicate that the output score 560 is not for a task relevant to the training example, the conditional loss function 570 computes a loss score that, when used to update the multitask model through a backpropagation process, does not change, or insubstantially changes, the parameters of the layers of the model. In cases where a higher loss score represents a worse performance by the multitask model, the conditional loss function 570 may compute a loss score of zero for the output score or a loss score that is low enough that parameters are not significantly changed through a backpropagation process using that loss score.

To compute different loss scores depending on whether the training example is relevant to a task for an output score, the conditional loss function 570 may multiply the output of a loss subfunction by an indicator bit corresponding to a task of the output score. As noted above, the task indicators 530 may be represented through indicator bits for each of the tasks, and each conditional loss function 570 may use the corresponding indicator bit for computing the loss score. For example, the conditional loss function 570 may use a subfunction that computes an initial loss score for the output score, and then multiply that initial score by the indicator bit corresponding to the branch of the conditional loss function. Thus, if the indicator bit is one (i.e., the task of the output score is relevant to the training example), the conditional loss function returns the initial loss score for the output score. If the indicator bit is zero (i.e., the task of the output score is not relevant to the training example), the conditional loss function returns zero.

Rather than having a conditional loss function for each branch, the online system may use a single conditional loss function for all branches and the conditional loss function has an input for an indicator of which branch computed an output score being evaluated by the conditional loss function. In these embodiments, the conditional loss function 570 may compare the input task indicators 530 to the indicator for the output score that indicates which task the output score corresponds to. If the indicator for the output score does not match one of the task indicators, the conditional loss function outputs a loss score of zero or a loss score that is low enough to not substantially change the parameters of the multitask model. Otherwise, the conditional loss function outputs a loss score that actually represents the performance of the multitask model.

As illustrated in FIG. 5, the task indicators 530 indicate that the training example 500 is relevant to the task corresponding to the second set of branch layers 550b. Thus, the conditional loss function 570 computes loss scores of zero (580a and 580n) for the output scores (560a and 560n), and computes a loss score 580b that represents the performance of the multitask model in computing the output score 560b from the second branch.

To update the multitask model, the online system backpropagates 340 through the sets of branch layers 550 and the set of shared layers 540 using the computed loss scores 580. Specifically, the online system backpropagates each loss score 580 through its corresponding set of branch layers 550 and then through the shared layers 540. For example, to train the multitask model using the loss scores 580 illustrated in FIG. 5, the online system backpropagates loss score 580a through the first set of branch layers 550a and through the shared layers. Similarly, the online system backpropagates loss score 580b through the second set of branch layers 550b and the shared layers 540, and backpropagates loss score 580n through the nth set of branch layers 550n and the set of shared layers 540. Since the loss scores for the first and nth set of branch layers are zero, the backpropagation process through the corresponding branch layers and the shared layers 540 does not cause the parameters for those layers to be updated. However, the non-zero loss score 580 means that the backpropagation process through branch layers 560b and the set of shared layers 540 does update the parameters in those layers.

The online system performs this process for each of the training examples in the accessed set of training examples. Once the multitask model is trained on each of the training examples, the online system stores 350 the parameters for the multitask model to a computer-readable medium. The stored multitask model may be used to perform tasks for the online system that the model was trained to perform using the above process. For example, the online system may receive data from a client device in communication with the online system. The online system may extract input features from the received data and apply the multitask model to the input features to generate output scores as described above. The online system may use these output scores to provide features or functionality for a client application operating on the user's client device.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A non-transitory computer-readable medium storing a set of parameters for a multitask model, wherein the set of parameters are produced by a process comprising:
initializing the multitask model comprising a plurality of layers of a multitask neural network, wherein the plurality of layers comprises a set of shared layers and a plurality of sets of branch layers, wherein each of the sets of branch layers corresponds to one of a plurality of tasks to be predicted by the multitask model, and wherein an output layer of the set of shared layers is connected to an input layer of each of set of branch layers;
accessing a set of training examples, wherein each training example comprises a set of input features, a plurality of task indicators, and a label, wherein each task indicator corresponds to one of the plurality of tasks and indicates whether the training example is relevant to the corresponding task;
for each of the set of training examples:
generating an output score corresponding to each of the plurality of tasks by applying the multitask model to the input features of the training example;
computing a loss score for each of the plurality of tasks based on the corresponding output score, the label of the training example, the task indicator of the training example, and a corresponding conditional loss function for the task, wherein a conditional loss function for a task is a loss function that computes a loss score of zero when the task indicators of a training example do not that indicate that the training example is relevant to the task of the conditional loss function; and
for each of the loss scores, backpropagating through the corresponding set of branch layers and the set of shared layers using the loss score to update a set of parameters of the set of branch layers and the set of shared layers; and
storing the sets of parameters of the set of shared layers and the plurality of sets of branch layers as the set of parameters for the multitask model.

2. The non-transitory computer-readable medium of claim 1, wherein the conditional loss function is further configured to:
compute a loss score reflecting a performance of the multitask model in computing an output score when the task indicators of a training example indicate that the training example is relevant to the task of the conditional loss function.

3. The non-transitory computer-readable medium of claim 2, wherein computing the loss score reflecting the performance of the multitask model comprises:
applying mean squared error, binary cross-entropy loss, categorical cross-entropy loss, Hinge loss, or KL divergence to compute the loss score.

4. The non-transitory computer-readable medium of claim 1, wherein each task indicator of the plurality of task indicators is an indicator bit.

5. The non-transitory computer-readable medium of claim 4, wherein the conditional loss function is configured to compute the loss score by:
multiplying an indicator bit for a corresponding task of the conditional loss function by a loss score computed by a loss subfunction.

6. The non-transitory computer-readable medium of claim 1, wherein the process is performed using a machine-learning programming library or a machine-learning platform.

7. The non-transitory computer-readable medium of claim 1, wherein each training example of the set of training examples comprises a set of labels, wherein each of the set of labels corresponds to a task indicator of the set of task indicators that indicates that the training examples is relevant to a corresponding task.

8. A method for training a multitask neural network, performed by a computer system comprising a processor and a computer-readable medium, comprising:
initializing a multitask model comprising a plurality of layers of a multitask neural network, wherein the plurality of layers comprises a set of shared layers and a plurality of sets of branch layers, wherein each of the sets of branch layers corresponds to one of a plurality of tasks to be predicted by the multitask model, and wherein an output layer of the set of shared layers is connected to an input layer of each of set of branch layers;
accessing a set of training examples, wherein each training example comprises a set of input features, a plurality of task indicators, and a label, wherein each task indicator corresponds to one of the plurality of tasks and indicates whether the training example is relevant to the corresponding task;
for each of the set of training examples:
generating an output score corresponding to each of the plurality of tasks by applying the multitask model to the input features of the training example;
computing a loss score for each of the plurality of tasks based on the corresponding output score, the label of the training example, the task indicator of the training example, and a corresponding conditional loss function for the task, wherein a conditional loss function for a task is a loss function that computes a loss score of zero when the task indicators of a training example do not that indicate that the training example is relevant to the task of the conditional loss function; and
for each of the loss scores, backpropagating through the corresponding set of branch layers and the set of shared layers using the loss score to update a set of parameters of the set of branch layers and the set of shared layers; and
storing the sets of parameters of the set of shared layers and the plurality of sets of branch layers as the set of parameters for the multitask model.

9. The method of claim 8, wherein the conditional loss function is further configured to:
compute a loss score reflecting a performance of the multitask model in computing an output score when the task indicators of a training example indicate that the training example is relevant to the task of the conditional loss function.

10. The method of claim 9, wherein computing the loss score reflecting the performance of the multitask model comprises:
applying mean squared error, binary cross-entropy loss, categorical cross-entropy loss, Hinge loss, or KL divergence to compute the loss score.

11. The method of claim 8, wherein each task indicator of the plurality of task indicators is an indicator bit.

12. The method of claim 11, wherein the conditional loss function is configured to compute the loss score by:
multiplying an indicator bit for a corresponding task of the conditional loss function by a loss score computed by a loss subfunction.

13. The method of claim 8, wherein the method is performed using a machine-learning programming library or a machine-learning platform.

14. The method of claim 8, wherein each training example of the set of training examples comprises a set of labels, wherein each of the set of labels corresponds to a task indicator of the set of task indicators that indicates that the training examples is relevant to a corresponding task.

15. A non-transitory computer-readable medium storing instructions that, when executed by a processor, cause the processor to perform operations comprising:
initializing a multitask model comprising a plurality of layers of a multitask neural network, wherein the plurality of layers comprises a set of shared layers and a plurality of sets of branch layers, wherein each of the sets of branch layers corresponds to one of a plurality of tasks to be predicted by the multitask model, and wherein an output layer of the set of shared layers is connected to an input layer of each of set of branch layers;
accessing a set of training examples, wherein each training example comprises a set of input features, a plurality of task indicators, and a label, wherein each task indicator corresponds to one of the plurality of tasks and indicates whether the training example is relevant to the corresponding task;
for each of the set of training examples:
generating an output score corresponding to each of the plurality of tasks by applying the multitask model to the input features of the training example;
computing a loss score for each of the plurality of tasks based on the corresponding output score, the label of the training example, the task indicator of the training example, and a corresponding conditional loss function for the task, wherein a conditional loss function for a task is a loss function that computes a loss score of zero when the task indicators of a training example do not that indicate that the training example is relevant to the task of the conditional loss function; and
for each of the loss scores, backpropagating through the corresponding set of branch layers and the set of shared layers using the loss score to update a set of parameters of the set of branch layers and the set of shared layers; and
storing the sets of parameters of the set of shared layers and the plurality of sets of branch layers as the set of parameters for the multitask model.

16. The non-transitory computer-readable medium of claim 15, wherein the conditional loss function is further configured to:
compute a loss score reflecting a performance of the multitask model in computing an output score when the task indicators of a training example indicate that the training example is relevant to the task of the conditional loss function.

17. The non-transitory computer-readable medium of claim 16, wherein computing the loss score reflecting the performance of the multitask model comprises:
applying mean squared error, binary cross-entropy loss, categorical cross-entropy loss, Hinge loss, or KL divergence to compute the loss score.

18. The non-transitory computer-readable medium of claim 15, wherein each task indicator of the plurality of task indicators is an indicator bit.

19. The non-transitory computer-readable medium of claim 18, wherein the conditional loss function is configured to compute the loss score by:
multiplying an indicator bit for a corresponding task of the conditional loss function by a loss score computed by a loss subfunction.

20. The non-transitory computer-readable medium of claim 15, wherein the process is performed using a machine-learning programming library or a machine-learning platform.
